(19) United States
(12) Patent Application Publication
(10) Pub. No.: US 2010/0051233 A1
(43) Pub. Date: Mar. 4, 2010

(54) HEAT-TRANSFERRING, HOLLOW-FLIGHT SCREW CONVEYOR

(76) Inventors: Preston Whitney, Concord, CA (US); Robert Nickerson, Vallejo, CA (US)

Correspondence Address: GARDNER GROFF GREENWALD & VILLANUEVA. PC, 2018 POWERS FERRY ROAD, SUITE 800, ATLANTA, GA, 30339, US

(21) Appl. No.: 12/552,369

(22) Filed: Sep. 2, 2009

Related U.S. Application Data
(60) Provisional application No. 61/190,885, filed on Sep. 2, 2008.

(51) Int. Cl. F28F 5/06; F26B 11/12

(52) U.S. Cl. 165/87; 99/443 C; 34/181

(57) ABSTRACT

A screw conveyor includes a steam delivery chamber, a condensate return chamber, and a helical hollow flight. In example embodiments, the condensate return chamber is defined by an inner pipe, the steam delivery chamber is defined between the outer and inner pipes, and the helical flight extends radially from the outer pipe. The screw conveyor includes a series of heating zones, each having a “closed-loop” helical passageway formed by the hollow flight and each having a corresponding steam inlet, condensate outlet, and barrier. Steam travels into the screw conveyor, through the steam inlets, and into the helical passageways, where it condenses as it heats a material conveyed by the screw conveyor. As the screw conveyor rotates, the barriers force the condensate upward until it drains through the condensate outlets and into the condensate return chamber for removal from the screw conveyor.

### CROSS-REFERENCE TO RELATED APPLICATION

This application claims the priority benefit of U.S. Provisional Patent Application Ser. No. 61/190,885, filed Sep. 2, 2008, which is hereby incorporated herein by reference.

### TECHNICAL FIELD

The present invention relates generally to screw conveyors for conveying a material and transferring heat relative to the conveyed material, and, in particular, to steam-heated, hollow-flight screw conveyors.

### BACKGROUND

Steam-heated, hollow-flight screw conveyors are commonly used to convey and transfer heat to a material. Common applications for such screw conveyors include cooking, heating, and drying of solid and semi-solid materials. In general, these screw conveyors have a helical flight that conveys the material as the screw conveyor is rotated. The flight is hollow so that it forms a helical passageway through which pressurized steam flows, thereby transferring heat to the conveyed material.

A drawback to conventional hollow-flight screw-conveyor designs is that they have limited lengths beyond which they do not work efficiently. As the steam passes through the helical passageway, condensate forms on the inner surfaces of the walls of the hollow flight and pools in the then-bottom portions of the rotating flight. The design length of these screw conveyors is limited by the number of flight revolutions that the steam can flow through before the accumulated condensate blocks the flow of the steam. In addition, conventional hollow-flight screw conveyors generally have low efficiencies because the significant amount of condensate that accumulates along the length of the helical passageway limits the energy transfer through the flight walls.

Accordingly, it can be seen that needs exist for improved heat-transferring, hollow-flight screw conveyors that have increased thermal efficiencies and/or can be designed with increased lengths. It is to the provision of solutions to these and other problems that the present invention is primarily directed.

### SUMMARY

Generally described, the present invention relates to a heat-transferring, hollow-flight screw conveyor that can be used to convey and transfer heat relative to a material. The screw conveyor includes a steam delivery chamber, a condensate return chamber, and a helical hollow flight. In example embodiments, the condensate return chamber is defined by an inner pipe, the steam delivery chamber is defined between the outer and inner pipes, and the helical flight extends radially from the outer pipe. The screw conveyor includes a series of heating zones, each having a “closed-loop” helical passageway formed by the hollow flight and each having a corresponding steam inlet, condensate outlet, and barrier. Steam travels into the screw conveyor, through the steam inlets, and into the helical passageways, where it condenses as it heats a material conveyed by the screw conveyor. As the screw conveyor rotates, the barriers guide the condensate upward until it drains through the condensate outlets and into the condensate return chamber for removal from the screw conveyor.

The specific techniques and structures employed by the invention to improve over the drawbacks of the prior devices and accomplish the advantages described herein will become apparent from the following detailed description of the example embodiments of the invention and the appended drawings and claims.

### BRIEF DESCRIPTION OF THE DRAWINGS

FIG. 1 is a side view of a heat-transferring, hollow-flight screw conveyor according to a first example embodiment of the present invention, shown in use with a steam-input/condensate-removal device.

FIG. 2 is a longitudinal cross-section view of the steam/condensate device of FIG. 1.

FIG. 3 is a longitudinal cross-section view of the left end of the screw conveyor and the steam/condensate device of FIG. 1, showing steam and condensate flowing therethrough.

FIG. 4 is a longitudinal cross-section view of the screw conveyor and steam/condensate device of FIG. 1, showing steam and condensate flowing through three heating zones of the screw conveyor.

FIG. 5 shows the second heating zone of the screw conveyor of FIG. 3, with the steam and condensate flowing therethrough.

FIG. 6 is an axial cross-section view of the screw conveyor of FIG. 3, taken at line 6-6 of FIG. 3.

FIG. 7 shows the screw conveyor of FIG. 6 as it rotates to scoop the condensate formed in the helical passageway defined by the hollow flight.

FIG. 8 shows the screw conveyor of FIG. 6 as it rotates further to direct the scooped condensate out of the helical passageway.

FIG. 9 is a longitudinal cross-section view of a heat-transferring, hollow-flight screw conveyor according to a second example embodiment of the present invention, shown in use with a steam-input device and a condensate-removal device with a siphon tube.

FIG. 10 is a perspective view of the left end of an alternative screw conveyor, showing three condensate diverters, instead of the siphon tube of FIG. 9, for removing the condensate from the screw conveyor.

### DETAILED DESCRIPTION OF EXAMPLE EMBODIMENTS

Generally described, the present invention relates to heat-transferring, hollow-flight screw conveyors that can be used to convey a material and transfer heat relative to the conveyed material. These screw conveyors can be used for conveying and heating a variety of numerous different materials, for example, cooking potatoes or fish meal, heating bakery mix, or drying coal. In typical commercial embodiments, steam is used to heat the screw conveyor, which then transfers heat to the conveyed material. In other embodiments, a heat-transferring media other than steam can be used, and for convenience “steam” as used herein includes such other heat-transferring media. In addition, the screw conveyors can be used with a heat-transferring media selected for removing heat from the conveyed material, though certain advantages of the invention may not be realized when cooling the conveyed material.

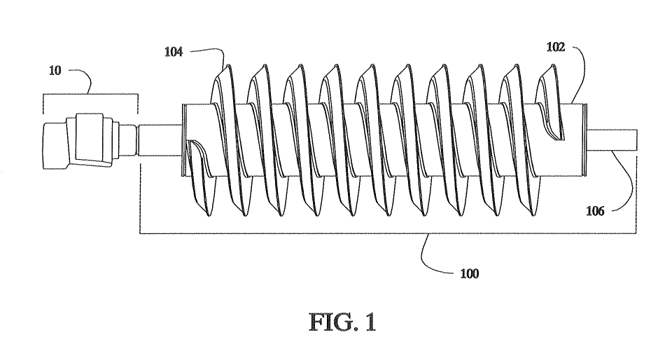

Referring now to the drawings, FIG. 1 shows a heat-transferring, hollow-flight screw conveyor 100 according to a first example embodiment of the present invention. The screw conveyor 100 includes an outer pipe 102 and a helical flight 104 extending radially outward from the outer pipe. The screw conveyor 100 can also include a distal shaft 106 extending longitudinally from the outer pipe. The distal shaft 106 can be rotated by a rotary drive mechanism (not shown) to drive the rotation of the screw conveyor 100. The rotary drive mechanism can be of a conventional type known in the art, and the screw conveyor 100 may be driven at the distal shaft, a proximal shaft, both, or another part of the conveyor.

The screw conveyor 100 is used in conjunction with a steam-input/condensate-removal device, which can be of a conventional type known in the art. The depicted steam/condensate device 10, for example, is a rotary joint design that inputs steam into the screw conveyor 100 and removes condensate from the screw conveyor. Such rotary joints are commercially available from manufacturers such as Kadant Inc. (Westford, Mass.).

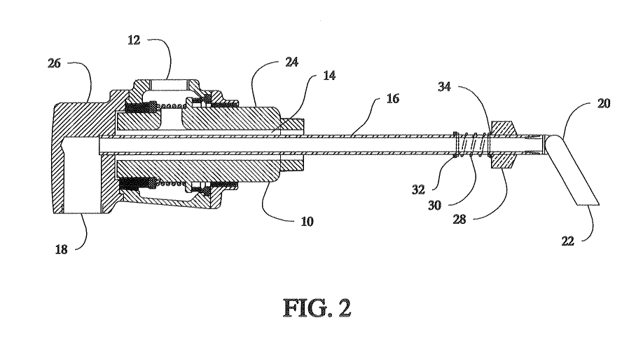

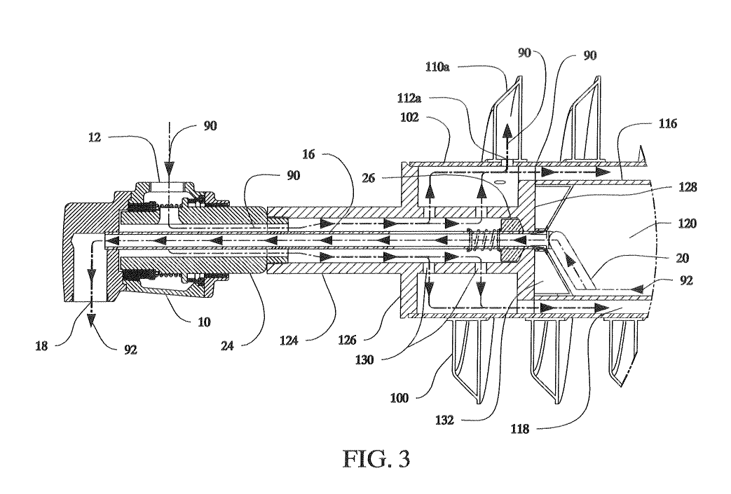

As shown in FIGS. 2-3, the depicted steam/condensate device 10 has a steam inlet 12 and an annular chamber 14 that permits steam 90 to the pass into the screw conveyor 100. The steam/condensate device 10 also has a siphon tube 16 and a condensate outlet 18 for removing the condensed water 92 from the screw conveyor 100. The siphon tube 16 inserts into the screw conveyor 100 and has a pivotal end 20 with an end opening 22 for receiving the condensate 92. The pivotal end 20 can include a pivotal coupling so that it pivots downward by gravity (upon insertion into the screw conveyor 100) and is held in place (e.g., by non-rotating housing 26) at a pre-set angle such as 30 or 60 degrees. A rotating annular body 24 couples to the screw conveyor 100, and the siphon tube 16 and the rotating body cooperatively define the annular chamber 14. The steam inlet 12 and the condensate outlet 18 are formed in a non-rotating housing 26, to which the siphon tube 16 is coupled to ensure that it does not rotate and the end opening 22 always points downward to remove the pooled condensate 92.

To provide a good seal, the steam/condensate device 10 includes an annular seal 28 such as a brass bushing that is biased against the screw conveyor 100 by a spring 30 such as a compression coil spring. The spring 30 biases against a retainer 32 such as a snap ring, and a washer 34 can be provided at the end of the spring 30 to prevent the spring from damaging the seal 28. The seal 28 functions to provide a seal between the stationary (non-rotating) siphon tube 16 and the rotating screw conveyor 100. Conventional systems have an opening between the siphon tube and the screw conveyor that allows steam to “short-circuit” directly to the condensate side of the system, and the present design avoids that problem. In addition, the seal 28 functions to provide a bearing surface for the non-rotating siphon tube 16. Conventional systems allow the siphon tube to be supported cantilever-like from the rotary joint, which can produce heavy wear between the siphon tube and the screw conveyor that can cause the siphon tube to fail, and the present design avoids that problem too.

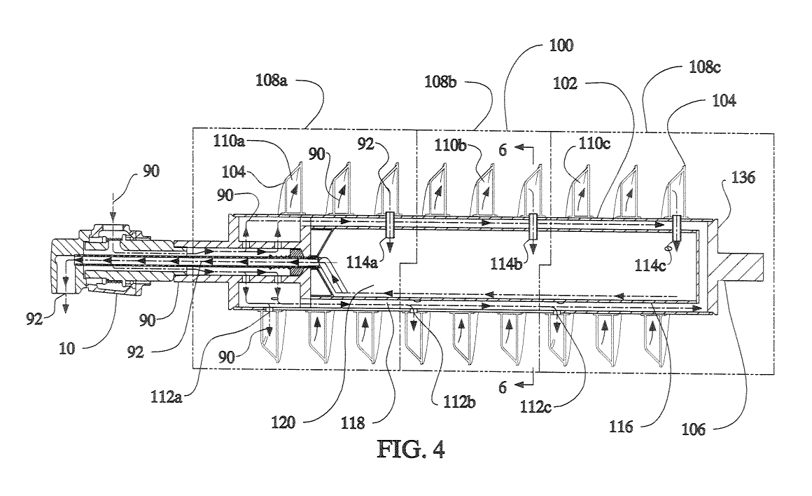

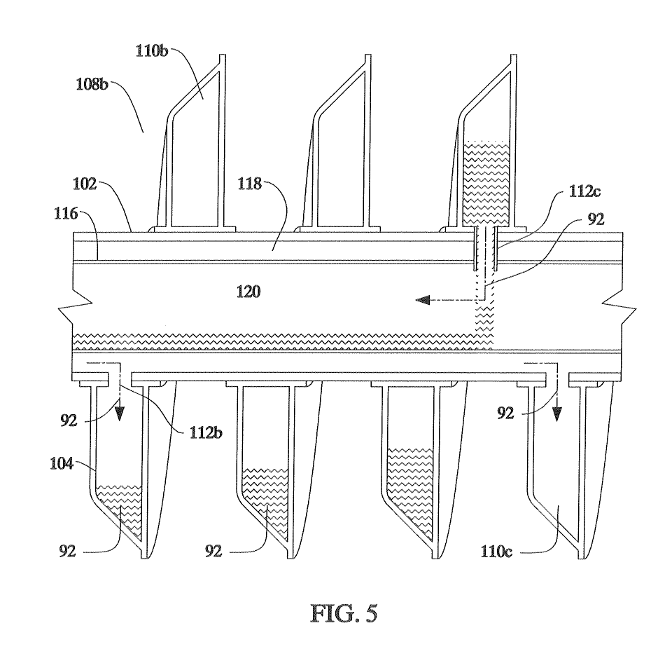

Referring now to FIGS. 4-5, the helical flight 104 of the screw conveyor 100 is hollow, with its walls forming a helical passageway through which the steam 90 flows to heat the material. Instead of a single continuous helical passageway, however, the screw conveyor 100 is divided into a series of heating zones with each zone having a dedicated “closed-loop” helical passageway. In the depicted embodiment, there are three serial heating zones 108a, 108b, and 108c (collectively, the “heating zones 108”), each having a corresponding helical passageway 110a, 110b, and 110c (collectively, the “helical passageways 110”), steam inlet 112a, 112b, and 112c (collectively, the “steam inlets 110”), condensate outlet 114a, 114b, and 114c (collectively, the “condensate outlets 114”), and barrier (not shown in FIGS. 4-5). The steam inlets 112 are positioned at the beginnings of the respective helical passageways 110, the barriers are positioned at and define the ends, and the condensate outlets 114 are positioned at the ends adjacent the barriers. In the depicted embodiment, the heating zones 108 are each formed by two-and-one-half revolutions of the flight 104. In other embodiments, the screw conveyor 100 has two or more than three serial heating zones and has the corresponding number of helical passageways, steam inlets, and condensate outlets. And in other embodiments, the heating zones 108 are each formed by fewer or more revolutions of the flight 104.

The screw conveyor 100 includes an inner pipe 116 that has an interior defining a condensate return chamber 120 and that is positioned within the outer pipe 102 with the space between them forming a steam delivery chamber 118. In the depicted embodiment, for example, the inner pipe 116 and the outer pipe 102 are cylindrical, coaxial, and concentrically arranged so that the condensate return chamber 120 is generally cylindrical and the steam delivery chamber 118 is generally annular. In other embodiments, the inner and/or outer pipes can be polygonal or have other regular or irregular cross-sectional shapes, and/or the inner pipe can be positioned within but not coaxial to the outer pipe. For example, the inner pipe can be provided with a tapered (e.g., conical) inner surface that is angled downward from the distal end toward the proximal end so that the condensate flows by gravity toward the proximal steam/condensate device for removal without the need to angle the screw conveyor. As another example, the inner pipe (including a tube or length of channel) can be attached to the inner surface of the outer pipe and define the steam delivery chamber, with the outer pipe (excluding the inner pipe volume) defining the condensate return chamber.

The steam inlets 112 are provided by openings in the outer pipe 102 that permit the steam 90 to flow from the steam delivery chamber 118 under about equal pressure into the helical passageways 110. And the condensate outlets 114 are provided by conduits extending from each helical passageway, through the steam delivery chamber 118, and into the condensate return chamber 120. In the depicted embodiment, for example, the condensate outlet conduits 114 are provided by tubes that sealingly extend through openings in the outer pipe 102 and the inner pipe 116. The condensate outlet conduits 114 preferably do not extend into the helical passageways 110, or do so only an insignificant length, so that the condensate 92 can fully drain out of the helical passageways. And the condensate outlet conduits 114 preferably extend into the inner pipe 116 a sufficient length so that, when the screw conveyor 100 is rotated to a position with one or more of them at the bottom, the condensate 92 in the inner pipe does not backflow into the helical passageways 110. In typical commercial embodiments, the condensate outlet conduits 110 extend into the inner pipe 116 by about one inch to about three inches.

In operation, the first heating zone 108a is heated by a first portion of the steam 90 flowing through the first steam inlet 112a and into the first helical passageway 110a. As heat from the steam 90 is transferred through the walls of the helical flight 104 to the conveyed material, the steam loses heat and water condenses on the inner surface of the flight walls in the first helical passageway 110a. This first portion of the condensate 92 then pools in the first helical passageway 110a at the portions that are at the bottom at any given rotational position of the screw conveyor 100. As the screw conveyor 100 rotates, the condensate 92 is conveyed along the helical flight 104 so that each bottom portion contains a successively larger volume of the condensate 92. The condensate 92 accumulates in and is conveyed along the first helical passageway 110a, but it is blocked from flowing past the barrier at the end of the first helical passageway. So the condensate 92 then flows through the first condensate outlet conduit 114a and into the condensate return chamber 120. When the condensate 92 flows at full capacity through the first condensate outlet conduit 114a, the steam 90 is prevented from flowing through it and leaking out of the first helical passageway 110a. But to the extent that some of the steam 90 does leak through the first condensate outlet conduit 114a, it is trapped in the condensate return chamber 120, so the pressure will equalize (in the steam delivery and condensate return chambers) and then no further steam can leak out.

Similarly, the second heating zone 108b is heated by a second portion of the steam 90 flowing past the first steam inlet 112a, farther along the steam delivery chamber 118, through the second steam inlet 112b, and into the second helical passageway 110b (see also FIG. 5). Then a second portion of the condensate 92 pools in and is conveyed along the second helical passageway 110b, but it is blocked from flowing past the barrier at the end of the second helical passageway. So the condensate 92 then flows through the second condensate outlet conduit 114b and into the condensate return chamber 120. This steam heating and condensate draining process is carried out in the same way by the third heating zone 108c and by any additional serial heating zones included in the screw conveyor 100.

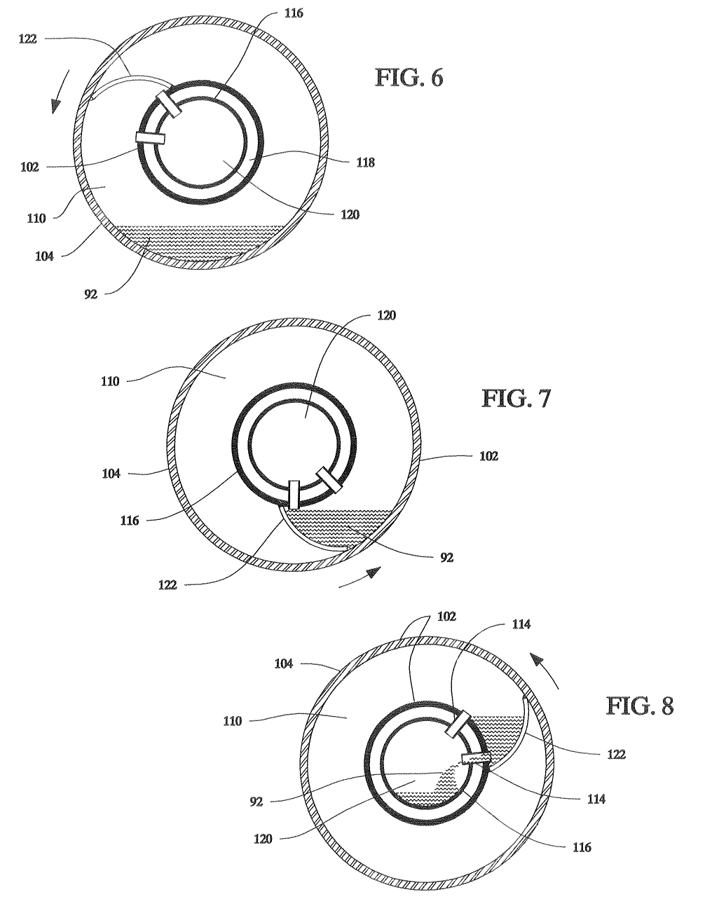

FIGS. 6-8 show how the barriers 122 function to direct the condensate 92 out of the helical passageways 110. In FIG. 6, the condensate 92 is pooled in a then-bottom portion of one of the helical passageways 110 as the screw conveyor 100 rotates (as indicated by the directional arrow). In FIG. 7, the screw conveyor 100 has been rotated so that the rotated barrier 122 at the end of the helical passageway 110 blocks passage of the condensate 92. In FIG. 8, the screw conveyor 100 has been rotated further so that the further-rotated barrier 122 forces the condensate 92 upward until it drains out of the helical passageway 110, through the condensate outlet conduit 114, and into the condensate return chamber 120. For applications in which a particularly large volume of condensate 92 is to be removed (e.g., for larger screw conveyors and/or long helical passageways), more than one condensate outlet conduit 114 can be provided for each of the helical passageways 110, for example as shown in FIGS. 6-8.

In the depicted embodiment, the screw conveyor 100 has a single continuous helical flight 104, with the barriers 122 positioned within the hollow flight to define the helical passageways 110. Thus, the first barrier separates the first heating zone 108a and the second heating zone 108b, with the first condensate outlet conduit 114a positioned adjacent and just before the first barrier and the second steam inlet 112b positioned adjacent and just after it (for clarity of illustration FIGS. 4-5 do not reflect this position of the condensate outlets). The barriers 122 can be provided by curved plates (as depicted), by angled or flat members such as plates, panels, blocks, or the like, or by other conventional structures for directing the condensate 92 out of the condensate outlet conduits 114. The barriers 122 extend between and are sealingly attached to the peripheral walls of the flight 104 to block the condensate 92 from flowing past them into the next helical passageway 110.

In other embodiments, the screw conveyor includes a series of independent hollow helical flights mounted to the outer pipe, with each one of the helical passageways defined by a respective one of the hollow flights, with the barriers defined by the distal end-walls of the respective hollow flights, and with a gap between the distal end of the first flight and the proximal end (beginning) of the second flight.

In yet other embodiments, the heating zones are not independent of each other, and instead the barriers permit at least some of the condensate to pass to the next helical passageway. In such embodiments, the barriers can include orifices or can not extend entirely across the helical passageway such that at least some of the condensate can pass to the next helical passageway. In these embodiments, however, a sufficient amount of the condensate is removed from the helical passageways to avoid blocking the steam flow and significantly reducing the thermal efficiency.

Referring back to FIG. 3, there are shown details of the proximal end of the screw conveyor 100, where the steam 90 enters the steam delivery chamber 118 and is removed from the condensate return chamber 120. In the depicted embodiment, the screw conveyor 100 includes a hollow access pipe 124, an outer end-wall 126, and an inner end-wall 128. The inner end-wall 128 is mounted to the inner pipe 116 to seal off the proximal (left) end of the condensate return chamber 120, and the outer end-wall 126 is mounted to the outer pipe 102 to seal off the proximal end of the steam delivery chamber 118. The outer and inner end-walls 126 and 128 can be provided by plates that are circular or have another shape for conforming and sealing to the outer and inner pipes 116 and 102. The access pipe 124 extends axially between the outer and inner end-walls 126 and 128 and extends axially out from the outer end-wall. The access pipe 124 couples to the rotating member 24 of the steam/condensate device 10 and receives the siphon tube 16. The steam 90 flows from the steam/condensate device 10, through the annular space 14 between the access pipe 124 and the siphon tube 16, and through openings 130 in the access pipe 124 to enter the steam delivery chamber 118. In other embodiments, the steam 90 is fed into the steam delivery chamber 118 by other structures such as passageways in a combined outer/inner end-wall (i.e., a manifold) or steam lines connected directly thereto.

In addition, the siphon tube 16 extends through an access opening in the inner end-wall 128 and into the condensate return chamber 120. The siphon tube 16 suctions out the condensate 92 that is drained into the condensate return chamber 120. In typical use, the screw conveyor 100 is oriented at a small angle (e.g., 5-10 degrees) relative to horizontal so that the condensate 92 flows by gravity toward the siphon tube 16. However, this causes the condensate 92 to accumulate in the space between the inner end-wall 128 and the end opening 22 of the pivotal end 20 of the siphon tube 16, which in turn causes rusting and premature deterioration of the screw conveyor 100. To remedy this problem, the screw conveyor 100 can be provided with spacer 132 that is positioned between the inner end-wall 128 and the pivotal end 20 of the siphon tube 16 and that is attached to the inner pipe 116 or the inner end-wall. In the embodiment shown in FIG. 3, the spacer 132 is provided by an annular conical member with a longitudinal cross-section in the general shape of two wedges facing each other. The hypotenuse conical surface is preferably at an angle relative to horizontal that generally conforms to the angle of the pivotal end 20 of the siphon tube 16, as shown in FIG. 3. In another embodiment, the spacer 132 is provided by a block such as a semi-annular conical member (e.g., a segment of the annular conical member, with a generally wedge-shaped cross-section) that, upon every revolution, displaces the pooled condensate 92 toward the siphon tube end 22. In this way, very little if any of the condensate 92 can remain in the condensate return chamber 120 after use. And in yet another embodiment, the spacer is included in a conventional “single-pass” hollow-flight screw conveyor with a single helical passageway and with the condensate return chamber defined by cylindrical space within the outer pipe (no inner pipe is provided).

The major components of the screw conveyor 100, such as the flight 104, the inner and outer pipes 116 and 102, the proximal inner and outer end-walls 128 and 126, the distal inner and outer end-walls 134 and 136, the barriers 122, and the condensate outlet conduits 114, can be made of metals selected for high strength and durability. In typical embodiments, these components are fabricated from commercially available steel component parts.

To use the screw conveyor 100, it is installed in place in a conventional manner (e.g., in a trough for holding a material to be conveyed and heated) and orientation (e.g., at a small angle from horizontal) as is known for using conventional hollow-flight screw conveyors. A drive mechanism is operably coupled to the screw conveyor 100 (e.g., to the distal shaft 106), the steam/condensate device 10 is mounted to the screw conveyor 100, the material is fed to the screw conveyor, a steam source is activated to deliver the steam 90 to the screw conveyor, and the drive controls are actuated to rotate the screw conveyor.

The screw conveyor 100 can be adapted for use in a variety of different applications. In some embodiments, the spacing and number of the barriers 122 can be changed to provide longer or additional helical passageways 110, depending on the anticipated volume of condensate formed in the helical passageways and the amount of heat to be transferred to the material. In some other embodiments, the steam inlets 112 can be provided in different peripheral sizes (e.g., diameters) so that more steam 90 enters the helical passageways 110 with larger-sized steam inlets. In such embodiments, each of the heating zones 108 can be designed for specific heat transfer properties independent of the other heating zones. So the screw conveyor 100 can be designed to transfer a specific first heat amount in the first zone, a specific second heat amount in the second zone, and a specific third heat amount in the third zone. In this way, the material can be subjected to high-BTU heat for a first predetermined period, then to low-BTU heat for a second predetermined period, and so on. This can be useful in applications in which it is desirable for the material to change phases at different heating zones, for example, between runny, sticky, gritty, powder, or other states, or where a particular phase needs less energy for the intended processing.

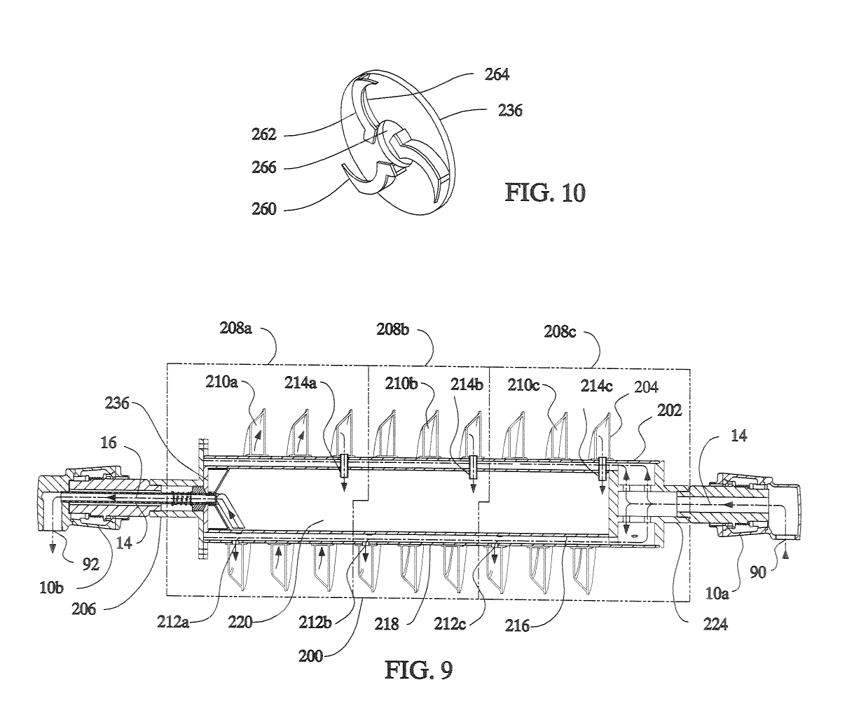

FIG. 9 depicts a heat-transferring, hollow-flight screw conveyor 200 according to a second example embodiment of the present invention. The screw conveyor 200 of this embodiment is similar to that of the first embodiment in its design and operation. It includes an inner pipe 216 defining a condensate return chamber 220, an outer pipe 202 cooperating with the inner pipe to define a steam delivery chamber 218, a helical hollow flight 204 extending radially from outer pipe, a hollow proximal shaft 224 extending longitudinally from the outer pipe, and a distal outer end-wall 236 attached to the outer pipe. The screw conveyor 200 is divided into a series of heating zones with each zone having a dedicated “closed-loop” helical passageway. In the depicted embodiment, there are three serial heating zones 208a, 208b, and 208c, each having a corresponding helical passageway 210a, 210b, and 210c, steam inlet 212a, 212b, and 212c, condensate outlet 214a, 214b, and 214c, and barrier (not shown).

In this embodiment, however, the screw conveyor 200 is of a “single-pass” design for steam entry and condensate removal at opposite ends (instead of at the same end as in the above-described “dual-pass” design). Thus, instead of being used with a combined steam/condensate device, the screw conveyor 200 is used with a steam-input device 10a having a steam chamber 14 and a condensate removal device 10b having a condensate chamber 16. The distal end of the screw conveyor 200 can have the same design as the first embodiment for attachment to the steam device 10a and delivery of steam 90 into the screw conveyor. But the proximal end of the screw conveyor 200 has a slightly different design. In the depicted embodiment, the screw conveyor 200 includes a hollow distal shaft 206 that extends longitudinally from the proximal end of the outer pipe 202. The condensate removal device 10b is mounted to the hollow distal shaft 206 and the condensate 92 is removed from the condensate return chamber 220, through the hollow distal shaft, and through the siphon tube 16 of the condensate removal device. The screw conveyor 200 may be driven at the proximal shaft, the distal shaft, both, or another part of the conveyor.

In addition, in this embodiment the steam inlets 212 are positioned closer to the condensate removal end of the screw conveyor 200 than the condensate outlets 214 are. For example, the first condensate outlet 214a is positioned at the proximal end of the first helical passageway 210a and the first steam inlet 212a is positioned at the distal end of the first helical passageway. So the steam 90 flows through the steam delivery chamber 218 longitudinally past where the first steam inlet conduit 212a is positioned to enter the first helical passageway 210a through the first steam inlet 212a. This configuration of the reversed steam inlets and condensate outlets allows for the steam 90 to flow in the same direction as the material is being conveyed, which is beneficial because the depicted flight 204 directs the condensate in that same direction.

The condensate can be removed by applying suction to the siphon tube 16 of the condensate removal device 10b or by another condensate removal structure. For example, FIG. 10 shows an alternative embodiment in which the screw conveyor 200 includes a condensate removal device 10c with a condensate diverter 260 instead of a siphon tube. The condensate removal device includes at least one vane 262 defining a diverter channel 264 extending radially inward from the outer pipe 202 to the hollow distal shaft 206. In the depicted embodiment, there are three radial vanes 262 attached to the inner surface of the distal outer end-wall 236, with each vane having a generally L-shaped cross-section and with the diverter channel 264 formed by the distal outer end-wall and the two walls of the L-shaped vane. As the screw conveyor 200 rotates, the rotating vanes 262 scoop the condensate 92 from the then-bottom of the condensate return chamber 220 and force it up to an access opening 266 in the distal outer end-wall 236 for removal through the hollow distal shaft 206 and the condensate removal device 10b.

It is to be understood that this invention is not limited to the specific devices, methods, conditions, and/or parameters of the example embodiments described and/or shown herein, and that the terminology used herein is for the purpose of describing particular embodiments by way of example only. Thus, the terminology is intended to be broadly construed and is not intended to be unnecessarily limiting of the claimed invention. For example, as used in the specification including the appended claims, the singular forms “a,” “an,” and “the” include the plural, the term “or” means “and/or,” and reference to a particular numerical value includes at least that particular value, unless the context clearly dictates otherwise. In addition, any methods described herein are not intended to be limited to the sequence of steps described but can be carried out in other sequences, unless expressly stated otherwise herein.

While the claimed invention has been shown and described in example forms, it will be apparent to those skilled in the art that many modifications, additions, and deletions can be made therein without departing from the spirit and scope of the invention as defined by the following claims.

What is claimed is:

1. A heat-transferring rotary screw conveyor for use with steam from which condensate forms, the screw conveyor comprising:
a steam delivery chamber;
a condensate return chamber;
at least one helical hollow flight;
a plurality of barriers that cooperate with the hollow flight to define a series of helical passageways through which the steam flows and in which the condensate forms;
a plurality of steam inlets, wherein a first one of the steam inlets is positioned to permit a first portion of the steam to flow from the steam delivery chamber into a first one of the helical passageways, and a last one of the steam inlets is positioned to permit a last portion of the steam to flow from the steam delivery chamber into a last one of the helical passageways; and
a plurality of condensate outlets, wherein a first one of the condensate outlets is positioned to permit a first portion of the condensate to flow from the first helical passageway into the condensate return chamber, and a last one of the condensate outlets is positioned to permit a last portion of the condensate to flow from the last helical passageway into the condensate return chamber.

2. The screw conveyor of claim 1, wherein the at least one helical hollow flight comprises a single helical hollow flight, and the plurality of barriers comprise a first barrier positioned within the hollow flight and a last barrier defined by an end-wall of the hollow flight.

3. The screw conveyor of claim 1, wherein the condensate accumulates in bottom portions of the helical passageways in the hollow flight, and, as the screw conveyor rotates, the barriers direct the accumulated condensate upward where it drains by gravity through the condensate outlets and into the condensate return chamber.

4. The screw conveyor of claim 1, further comprising an outer pipe and an inner pipe positioned within the outer pipe, wherein the helical hollow flight extends radially outward from the outer pipe.

5. The screw conveyor of claim 4, wherein the inner pipe defines the condensate return chamber, and the inner pipe and the outer pipe cooperatively define the steam delivery chamber.

6. The screw conveyor of claim 5, wherein the inner pipe and the outer pipe are coaxially arranged and the steam delivery chamber is defined by an annular space formed between them.

7. The screw conveyor of claim 5, wherein the steam inlets comprise openings defined in the outer pipe.

8. The screw conveyor of claim 5, wherein the condensate outlets comprise conduits extending from the helical passageways, through the steam delivery chamber, and into the condensate return chamber.

9. The screw conveyor of claim 1, further comprising a proximal end-wall and a proximal hollow access pipe extending therethrough, wherein the steam enters the screw conveyor through the hollow access pipe and the condensate exits the screw conveyor through the hollow access pipe.

10. The screw conveyor of claim 1, further comprising a proximal end-wall, a proximal hollow access pipe extending therethrough, a distal end-wall, and a distal hollow access pipe extending therethrough, wherein the steam enters the screw conveyor through the proximal hollow access pipe and the condensate exits the screw conveyor through distal hollow pipe.

11. The screw conveyor of claim 1, wherein the first helical passageway defines a first heating zone and the last helical passageway defines a last heating zone.

12. A heat-transferring rotary screw conveyor for use with steam from which condensate forms, the screw conveyor comprising:
an outer pipe at least partially defining a steam delivery chamber and a condensate return chamber;
at least one helical hollow flight extending radially outward from the outer pipe;
a plurality of barriers that cooperate with the hollow flight to define a series of helical passageways through which the steam flows and in which the condensate forms, wherein a first one of the helical passageways defines a first heating zone and a last one of the steam inlets defines a last heating zone;
a plurality of steam inlets, wherein a first one of the steam inlets is positioned to permit a first portion of the steam to flow from the steam delivery chamber into the first helical passageway, and the last helical passageway is positioned to permit a last portion of the steam to flow from the steam delivery chamber into a last one of the helical passageways; and
a plurality of condensate outlets, wherein a first one of the condensate outlets is positioned to permit a first portion of the condensate to flow from the first helical passageway into the condensate return chamber, and a last one of the condensate outlets is positioned to permit a last portion of the condensate to flow from the last helical passageway into the condensate return chamber,
wherein the condensate accumulates in bottom portions of the helical passageways in the hollow flight, and, as the screw conveyor rotates, the barriers direct the accumulated condensate upward where it drains by gravity through the condensate outlets and into the condensate return chamber.

13. The screw conveyor of claim 12, wherein the at least one helical hollow flight comprises a single helical hollow flight, and the plurality of barriers comprise a first barrier positioned within the hollow flight and a last barrier defined by an end-wall of the hollow flight.

14. The screw conveyor of claim 12, wherein the steam inlets comprise openings defined in the outer pipe.

15. The screw conveyor of claim 12, further comprising an inner pipe positioned within the outer pipe, wherein the inner pipe defines the condensate return chamber, and the inner pipe and the outer pipe cooperatively define the steam delivery chamber.

16. The screw conveyor of claim 15, wherein the inner pipe and the outer pipe are coaxially arranged and the steam delivery chamber is defined by an annular space formed between them.

17. The screw conveyor of claim 15, wherein the condensate outlets comprise conduits extending from the helical passageways, through the steam delivery chamber, and into the condensate return chamber.

18. A heat-transferring rotary screw conveyor for use with a device that removes condensate therefrom, the screw conveyor comprising:
a rotatable outer pipe;
at least one helical hollow flight extending radially outward from the outer pipe and defining at least one helical passageway;
a condensate return chamber positioned within the outer pipe;
an end-wall defining an access opening in communication with the condensate return chamber; and
a means for transporting the condensate in the condensate return chamber to the condensate removal device.

19. The screw conveyor of claim 18, wherein the condensate removal device includes a siphon tube with an end that extends through the access opening and into the condensate return chamber, and wherein the condensate transport means includes a spacer positioned within the condensate return chamber between the end-wall and the siphon tube end to displace the condensate from the position of the spacer toward the siphon tube end, wherein the spacer has at least a portion with a wedge-shaped cross-section.

20. The screw conveyor of claim 18, wherein the condensate transport means includes at least one vane defining a diverter channel mounted to the end-wall and extending radially inward from the outer pipe to the access opening.
